(19) United States
(12) Patent Application Publication
(10) Pub. No.: US 2006/0102098 A1
(43) Pub. Date: May 18, 2006

(54) Animal toy

(75) Inventor: Jonathan Zelinger, Bloomfield, NJ (US)

Correspondence Address: KATTEN MUCHIN ROSENMAN LLP, 575 MADISON AVENUE, NEW YORK, NY, 10022-2585, US

(73) Assignee: ETHICAL PRODUCTS, INC.

(21) Appl. No.: 11/266,556

(22) Filed: Nov. 3, 2005

Related U.S. Application Data
(60) Provisional application No. 60/624,581, filed on Nov. 3, 2004.

(51) Int. Cl. A01K 29/00

(52) U.S. Cl. 119/707

(57) ABSTRACT

An animal toy having a solid core and a covering having an abrasive texture is disclosed. In one or more embodiments, the covering is made of multiple pieces which may be heat-welded at a periphery of the animal toy.

### RELATED APPLICATION

The present invention application is a non-provisional counterpart to and claims priority from U.S. Application 60/624,581 filed on Nov. 3, 2004, which is hereby incorporated in its entirety by reference.

### FIELD OF THE INVENTION

The present invention relates to animal toys generally and more particularly to animal toys having solid cores and tennis coverings.

### BACKGROUND OF THE INVENTION

Domesticated animals often include prey animals such as cats and dogs. Dogs especially love to chase an object and bite on it. Thus, a popular activity for dog owners is to play fetch.

Typically, animal toys are made to be hollow. These toys are lightweight, have thin shelled walls, and can be readily thrown and subsequently retrieved by animals. Yet, these toys are often also easily destroyed because of their flimsy nature.

One commonly used toy with animals is a tennis ball. Tennis balls inherently have a bounce that lends unpredictability to playing fetch. It is believed that dogs like the bounce effect because it simulates activities of prey. The acrylic covering of tennis balls is believed to be preferred by dogs because of its complex texture when in the dog's mouth.

However, what hollow toys like the tennis ball are missing is the feel of prey. For example, a hollow toy is significantly lighter than a similarly sized prey animal and does not have the resilient feel of a prey animal.

Furthermore, hollow toys with thin-shelled walls are not capable of being thrown over a great distance because of their relative minimal weight.

However, certain breeds of dogs are very rough with toys. For example, a German shepherd is typically capable of biting through a tennis ball.

Therefore, what is desired is an animal toy that has a feel that is closely simulated to actual prey, i.e., the meat, and that is easy to throw over great distances. What is also desired is an animal toy that has a covering that is liked by animals and especially by dogs. Furthermore, what is desired is a animal toy that is easy to manufacture, economical to ship, and is durable.

### SUMMARY OF THE INVENTION

The objects of the invention are provided for in an animal toy comprising a solid core and a covering having an adhesive texture and being glued to the solid core. In at least one embodiment, the solid core comprises a natural latex rubber.

In one embodiment, the covering comprises a texture similar to the texture of a tennis ball covering and may be made of acrylic. In a further embodiment the covering comprises chenille.

In yet a further embodiment the covering comprises a plurality of pieces that are advantageously heat-welded together. One location for such a weld is made at a periphery of the animal toy.

In one embodiment, a method of making the animal toy comprises providing a solid core and a covering that is glued to the covering. The covering may comprise a plurality of pieces that are heat-welded together at, for example, a periphery of the animal toy.

A system of animal toys comprises a plurality of solid cores that vary in flexibility. In one embodiment, the flexibility of the solid cores are varied to suit a specific breed of animal.

### BRIEF DESCRIPTION OF THE DRAWING FIGURES

FIG. 1 is a plan view of the animal toy 10 of the present invention; and

FIG. 2 is a cross-sectional view along line A-A of the animal toy 10 of the present invention.

### DETAILED DESCRIPTION OF THE DRAWING FIGURES

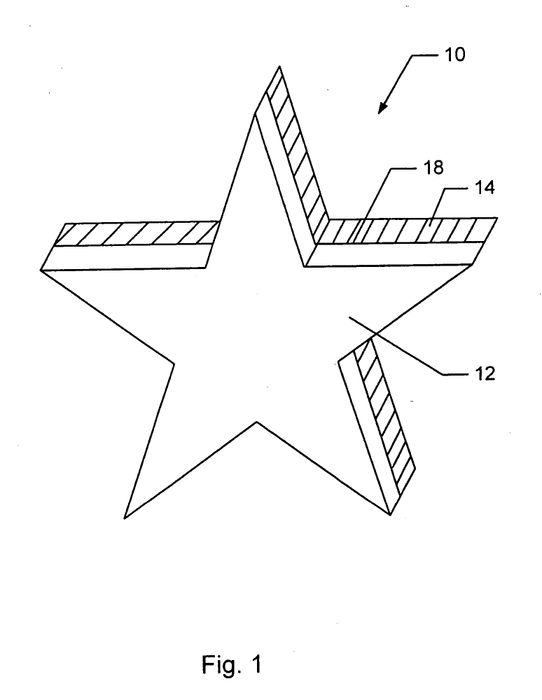

FIG. 1 represents a star-shaped animal toy. However, all kinds of styles and sizes may be used. Common styles of animal toy 10 may include sticks, bones, doughnuts, animal figures or any other style that is suitably interesting to dog owners and/or owners of other prey animals.

It is preferred that animal toy 10 is not larger than eleven (11) inches, since this is the upper range of what is considered throwable by a user, i.e., a dog owner, and safely grabable by a dog. Thus, animal toy 10 should have a substantial and thick feeling wherein the center of animal toy 10 is thicker than the edges. Yet, the edges are rounded and thick.

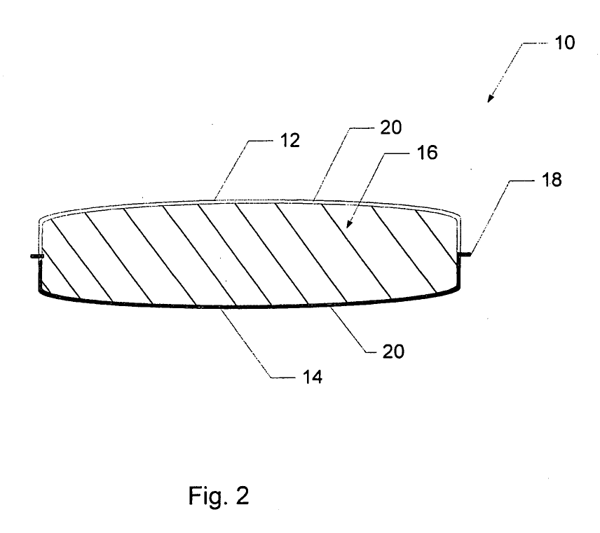

Turning now to FIG. 2, animal toy 10 includes a first covering 12, a second covering 14, a core 16, and a weld 18 along a periphery of animal toy 10.

First covering 12 and second covering 14 preferably are made of acrylic. This material may also be referred to as tennis material covering, since it is similar to the material covering tennis balls. The covering material for first and second coverings 12 and 14, respectively, are preferred by dogs and their owners because the abrasive texture has plaque- and gum-cleaning properties. In one embodiment, chenille may also be used as a covering material.

First and second coverings 12 and 14, respectively, cover a solid core, core 16, which is made of natural latex rubber, clay and calcium carbonate. These components may be mixed in differing amounts to vary the flexibility of the core, and, thus, effectively make animal toy 10 either stiffer or more flexible. Accordingly, animal toy 10 may be provided in the same shape but in different flexural strength for different breeds of dogs.

The covering material for first and second covering 12 and 14 are glued onto core 16 using a glue 20. Any kind of glue suitable for the purpose may be used.

To make animal toy 10 attractive, first and second covering 12 and 14 respectively may have different colors. For example, in one embodiment, first covering 12 may be a vinyl red while second covering 14 may be white.

A peripheral weld 18 is created by heat welding the first and second covering 12 and 14 respectively to each other. Therein, it is advantageous to arrange the weld 18 so as to be along a periphery that is not whimsical.

In one embodiment, animal toy 10 is made of a plurality of coverings. Thus, not only would animal toy 10 in FIG. 1 be made out of a first and second covering 12 and 14 respectively, but also would include a third, fourth, fifth and perhaps even more coverings. Each of the plural covering, for example, may be glued onto one part of the animal toy and then heat-welded at a suitable seam to the coverings adjacent to it.

Advantageously, the present invention of an animal toy 10 floats in water. Unlike hollow animal toys, even if the covering is punctured, animal toy 10 will continue to retain its shape and will continue to float.

The present invention of the animal toy 10 is also significantly more durable than toys, which are filled with air and that can easily puncture. The present invention of animal toy 10 furthermore feels meatier than toys that are hollow, and thus, are able generally to be thrown further than comparably sized hollow toys.

While the present invention has been described at some length and with some particularity with respect to the described embodiment, it is not intended that it should be limited to any such particular embodiment, but it is to be construed with references to the appended claims so as to provide the broadest possible interpretation of such claims in view of the prior art and, therefore, to effectively encompass the intended scope of the invention. For instance, animal toys having different shapes, or toys adapted for other types of animals are also contemplated. Furthermore, the foregoing describes the invention in terms of the embodiment foreseen by the inventor for which an enabling description was available, notwithstanding that insubstantial modifications of the invention, not presently foreseen, may nonetheless represent equivalents thereto.

1. An animal toy comprising:
a solid core comprising natural latex rubber; and
a covering comprising a textured abrasive surface, the covering glued to the solid core.

2. The animal toy of claim 1, wherein the covering comprises a texture of a tennis ball covering.

3. The animal toy of claim 1, wherein the covering comprises a plurality of pieces.

4. The animal toy of claim 3, wherein the pieces are heat-welded to each other.

5. The animal toy of claim 3, wherein the pieces are heat-welded to a common periphery of the animal toy.

6. The animal toy of claim 3, wherein the pieces are heat-welded to each other at seams common to two pieces.

7. The animal toy of claim 1, wherein the covering comprises acrylic.

8. The animal toy of claim 1, wherein the covering comprises chenille.

9. An animal toy comprising:
a solid core having a flexibility similar to prey;
a covering comprising an abrasive texture, the covering glued to the solid core.

10. The animal toy of claim 9, wherein the solid core comprises natural latex rubber, clay, and calcium carbonate.

11. The animal toy of claim 9, wherein the covering comprises a plurality of pieces.

12. The animal toy of claim 11, wherein at least two of the pieces are heat-welded to each other.

13. The animal toy of claim 11, wherein the subcoverings are welded to each other along a periphery of the animal toy.

14. The animal toy of claim 9, wherein the covering is acrylic.

15. The animal toy of claim 14, wherein the covering is chenille.

16. The animal toy of claim 14, wherein the covering comprises the texture of a tennis ball covering.

17. A method of making an animal toy having a solid core and covering having an abrasive covering texture, the method comprising the steps of:
providing a solid core;
providing a covering having an abrasive texture, and;
gluing the covering to the solid core.

18. The method of claim 17, wherein the covering comprises a plurality of pieces and the method comprises that the step of gluing the covering to the solid covering is performed as the step of gluing the pieces to the solid core.

19. The method of claim 18, wherein at least one of the plurality of the pieces are heat-welded to at least one other of the plurality of the pieces.

20. The method of claim 19, wherein the pieces are heat-welded at a periphery of the animal toy.

21. A system of animal toys comprising:
a first animal toy comprising a first solid core and a first covering having an abrasive texture and being glued to the first solid core;
a second animal toy comprising a second solid core and a second covering having the abrasive texture and being glued to the second core;
wherein the first solid core and second solid core differ in flexibility.

22. The system of claim 21 wherein the flexibility of the solid core is specifically suitable for a breed of animal.
